(19) United States
(12) Patent Application Publication
(10) Pub. No.: US 2017/0343805 A1
(43) Pub. Date: Nov. 30, 2017

(54) METHOD AND APPARATUS FOR IN-VEHICULAR COMMUNICATIONS

(71) Applicant: SenseDriver Technologies LLC, Malden, MA (US)

(72) Inventors: Michael Amaru, Reading, MA (US); Aditya Humad, Cambridge, MA (US); Kingsley Chin, Fort Lauderdale, FL (US)

(21) Appl. No.: 15/606,438

(22) Filed: May 26, 2017

Related U.S. Application Data
(60) Provisional application No. 62/342,445, filed on May 27, 2016.

(51) Int. Cl. G02B 27/01; B60R 11/02; H04N 9/31; G02F 1/1335; B60R 11/00

(52) U.S. Cl. CPC G02B 27/0101; H04N 9/3173; G02F 1/133555; G02F 1/133502; G02B 27/0149; B60R 11/0241; B60R 2011/027; B60R 2011/0026; B60R 2011/0005; G02B 2027/0118

(57) ABSTRACT

A vehicular heads-up-display system includes an apparatus having a base configured to receive and maintain a pico-projector case in combination with a handheld electronic device, and to output optical transmissions from the pico-projector case to an at least partially reflective surface to form a heads-up display. The partially reflective surface may be a combiner and/or mirror coupled to a base comprising the holder. The handheld electronic device may be a smartphone. For example, the system can be used to cause a pico-projector to project information from a smartphone to a partially reflective mirror for viewing by a vehicle operator.

### CROSS REFERENCE TO RELATED APPLICATIONS

This application claims the benefit of priority under 35 U.S.C. §119(e) from co-pending, commonly owned U.S. provisional patent application Ser. No. 62/342,445, entitled METHOD AND APPARATUS FOR IN-VEHICULAR COMMUNICATIONS, filed May 27, 2016, the contents of which are incorporated herein by reference.

### FIELD OF INTEREST

Inventive concepts relate to the field of cellular telephones, and more particularly to the field of smartphones.

### BACKGROUND

Cellular telephones have become ubiquitous, and, with the advent and growing popularity of smartphones, not only are they a dominant force in voice communications, they increasingly play a role in data communications. The term “smartphone” is generally employed to refer to a cellular telephone that provides features beyond simply voice communications, such as geographical mapping and navigation (using, for example, global positioning system (GPS) links), access to musical libraries, Internet access, and non-voice messaging, such as texting, for example. Such features may be provided by applications, often referred to as “apps.” Smartphones may operate using any of a variety of platforms, using any of a variety of operating systems, available from a number of cell-phone manufacturers and cellular service providers.

Although such applications are convenient and popular, many automobile accidents are now attributed to a driver's use of a cell phone or smartphone while driving. As a result, a number of states ban drivers from text messaging while driving and some states even ban the use of a cell phone while driving. Many countries ban all cell phone use while driving. These measures have been undertaken, in part, because a driver's use of a telephone can distract the driver from the primary responsibility of safe driving. Three types of distraction attributable to cell phone usage while driving are now widely recognized: visual distraction occurs when the driver takes his or her eyes off the road to view his cell phone; manual distraction/mechanical distraction may occur when a driver removes one or both hands from the steering wheel to operate his cell phone; and either visual or manual distraction (or other distractions) can lead to a cognitive distraction whereby a driver's reaction time may be impaired.

Although systems and methods have been developed or proposed to minimize distractions attributable to cell phone usage, problems remain and, as a result, a need exists for a system that provides non-distracting cell phone usage.

### SUMMARY

In accordance with an aspect of the inventive concept, provided is a vehicular heads-up-display (HUD) system, comprising an optical path having an at least partially reflective medium mounted for heads-up viewing in a vehicle and a base configured to receive a pico-projector case having a smartphone, wherein the base is structured to align a pico-projector lens so that its images are received by the at least partially reflective medium via the optical path.

In some embodiments, the at least partially reflective medium is a switchable mirror.

In some embodiments, the switchable mirror comprises an electrically switchable transreflective mirror.

In some embodiments, the system is responsive to a light sensor to control the reflectance and/or transmissivity of the switchable mirror.

In some embodiments, the system is responsive to a vehicle speed sensor to control the reflectance of the switchable mirror.

In some embodiments, the system is configured to increase the reflectance of the switchable mirror when the vehicle speed sensor indicates that the vehicle is not traveling.

In some embodiments, the switchable mirror includes a plurality of liquid crystal layers that operate as first and second mirror layers.

In some embodiments, the system further comprises a first mirror layer having a reflectance of or about 50% and a second mirror layer having a reflectance of or about 40%.

In some embodiments, the system further comprises a third layer as a “frost” layer that, under electronic control, switches from translucent to highly reflective.

In some embodiments, the system further comprises one or more protective layers that seal the liquid crystal layers and one or more anti-reflective coatings formed over the one or more protective layers.

In some embodiments, the optical path includes a mirror coupled to the base and oriented to reflect the output of the pico-projector lens to the at least partially reflective medium.

In some embodiments, the pico-projector case is maintained by the base between the mirror and the at least partially reflective medium.

In some embodiments, the optical path includes at least one optical element configure to invert, reverse, and/or resize images projected from the pico-projector lens.

In accordance with another aspect of the inventive concept, provided is a vehicular heads-up-display (HUD) system, comprising a base configured to receive a pico-projector case having a smartphone and a pico-projector lens configured to output images from the smartphone and an optical path. The optical path comprises an at least partially reflective medium mounted for heads-up viewing and a mirror oriented to reflect the output images of the pico-projector lens to the at least partially reflective medium.

In some embodiments, the base includes a compartment, recess, slot, or depression configured to receive the pico-projector case.

In some embodiments, the pico-projector case is maintained within the compartment, recess, slot, or depression of the base and between the mirror and the at least partially reflective medium.

In some embodiments, the system is configured to adjust the reflectance of the switchable mirror.

In some embodiments, the system is configured to increase the reflectance of the switchable mirror when the vehicle speed sensor indicates that the vehicle is not traveling.

In some embodiments, the switchable mirror includes a plurality of liquid crystal layers that operate as first and second mirror layers, including a first mirror layer having a reflectance of or about 50%, a second mirror layer having a reflectance of or about 40%, and a third layer as a “frost” layer that, under electronic control, switches the reflectance of the switchable mirror.

In some embodiments, the system further comprises at least one mount to mount the system to a dashboard or windshield of a vehicle.

In some embodiments, a vehicular heads-up-display system includes an at least partially reflective medium mounted for heads-up viewing in a vehicle; and a base configured to accept a smartphone and a pico-projector and to project the display of the portable electronic device to the medium.

In some embodiments, the system can further comprise a mounting bracket configured to mount the apparatus to a vehicle surface or component.

In some embodiments, the mounting bracket can be configured to mount the apparatus to a vehicle windshield.

In some embodiments, the mounting bracket can be configured to mount the apparatus to a vehicle dashboard.

In some embodiments, the system can further comprise a remote control device configured to interact with the electronic device to control the optical output of the pico-projector.

In some embodiments, the medium can be switchable mirror.

In some embodiments, a vehicular heads-up-display system includes a display system as shown and described herein, wherein the switchable mirror comprises an electrically switchable transreflective mirror.

In some embodiments, a vehicular heads-up-display system includes a display system as shown and described herein, wherein the system is configured to display navigational information.

In some embodiments, a vehicular heads-up-display system includes a display system as shown and described herein, wherein the system is configured to display musical selection information.

In some embodiments, a vehicular heads-up-display system includes a display system as shown and described herein, wherein the system is configured to display vehicle parameters.

In some embodiments, a vehicular heads-up-display system includes a display system as shown and described herein, wherein the system is configured to display vehicle parameters including vehicle speed.

In some embodiments, a vehicular heads-up-display system includes a display system as shown and described herein, wherein the system is configured to be responsive to voice commands.

In some embodiments, a vehicular heads-up-display system includes a display system as shown and described herein, wherein the system is configured to control the switchable mirror to be highly reflective when the vehicle is not traveling.

In some embodiments, a vehicular heads-up-display system includes a display system as shown and described herein, wherein the system is configured to provide web browsing when the vehicle is not traveling.

In some embodiments, a vehicular heads-up-display system includes a display system as shown and described herein, wherein the system is configured to collect and store data.

In some embodiments, a vehicular heads-up-display system includes a display system as shown and described herein, wherein the system is configured to store data including, vehicle speed, vehicle location, and music information.

In some embodiments, a vehicular heads-up-display system includes a display system as shown and described herein, wherein the system is configured to upload data to cloud storage.

In some embodiments, a vehicular heads-up-display system includes a system for providing information to a driver in a vehicle, including a smartphone with a display configured for two-way communications with other devices and programmable control; a pico-projector; a partially reflective combiner glass, that reflects the smartphone display received from the pico-projector into the field of view of the driver as a heads-up display for the driver; and a base to support the smartphone and partially reflective combiner glass and to position them for transmission of the smartphone display information to the partially reflective combiner glass.

In some embodiments, a vehicular heads-up-display system includes a display system as shown and described herein wherein the mobile telephone includes telephone input means for enabling a user to provide input thereto and said programmable control defines a driving mode wherein the tactile input device is the sole source of input by the driver and the telephone input means is disabled and a non-driving mode wherein the telephone input means is enabled.

In some embodiments, a vehicular heads-up-display system method includes providing a switchable mirror mounted for heads-up viewing in a vehicle; and providing a base configured to accept a smartphone and pico-projector and to project the display of the portable electronic device to the switchable mirror when mounted in a vehicle.

In some embodiments, a vehicular heads-up-display system method includes displaying information in a vehicle including a display system as shown and described herein, wherein the switchable mirror comprises an electrically switchable transreflective mirror.

In some embodiments, a vehicular heads-up-display system method includes displaying information in a vehicle including a display system as shown and described herein, wherein the system is configured to display navigational information.

In some embodiments, a vehicular heads-up-display system method includes displaying information in a vehicle including a display system as shown and described herein, wherein the system is configured to display musical selection information.

In some embodiments, a vehicular heads-up-display system method includes displaying information in a vehicle including a display system as shown and described herein, wherein the system is configured to display vehicle parameters.

In some embodiments, a vehicular heads-up-display system method includes displaying information in a vehicle including a display system as shown and described herein, wherein the system is configured to display vehicle parameters including vehicle speed.

In some embodiments, a vehicular heads-up-display system method includes displaying information in a vehicle including a display system as shown and described herein, wherein the system is configured to be responsive to voice commands.

In some embodiments, a vehicular heads-up-display system method includes displaying information in a vehicle including a display system as shown and described herein, wherein the system is configured to control the switchable mirror to be highly reflective when the vehicle is not traveling.

In some embodiments, a vehicular heads-up-display system method includes displaying information in a vehicle including a display system as shown and described herein, wherein the system is configured to provide web browsing when the vehicle is not traveling.

In some embodiments, a vehicular heads-up-display system method includes displaying information in a vehicle including a display system as shown and described herein, wherein the system is configured to collect and store data.

In some embodiments, a vehicular heads-up-display system method includes displaying information in a vehicle including a display system as shown and described herein, wherein the system is configured to store data including, vehicle speed, vehicle location, and music information.

In some embodiments, a vehicular heads-up-display system method includes displaying information in a vehicle including a display system as shown and described herein, wherein the system is configured to upload data to cloud storage.

In some embodiments, a vehicular heads-up-display system method includes a smartphone with a display employing two-way communications with other devices and programmable control; a partially reflective combiner glass reflecting smartphone display received from a pico-projector into the field of view of the driver as a heads-up display for the driver; and a base supporting the smartphone and partially reflective combiner glass and to position them for transmission of the smartphone display information to the partially reflective combiner glass.

In some embodiments, a vehicular heads-up-display system method includes displaying information in a vehicle having a display system as shown and described herein wherein the mobile telephone includes telephone input means for enabling a user to provide input thereto and said programmable control defines a driving mode wherein the tactile input device is the sole source of input by the driver and the telephone input means is disabled and a non-driving mode wherein the telephone input means is enabled.

In some embodiments, a vehicular heads-up-display system, comprises an apparatus having a holder configured to receive and maintain a pico-projector in combination with a handheld electronic device, and to output optical transmissions from the pico-projector to an at least partially reflective medium to form a heads-up display.

In some embodiments, the medium can have a reflective surface that is substantially vertical, or within a range of plus or minus 30 degrees from vertical.

In some embodiments, the medium can be a surface of a windshield facing a vehicle operator.

In some embodiments, the medium can be a surface of a windshield internal to a vehicle.

In some embodiments, the medium can be a combiner and/or mirror.

In some embodiments, the medium can be coupled to a base comprising the holder.

In some embodiments, the base can define a compartment or cavity configured to receive the pico-projector in combination with a handheld electronic device.

In some embodiments, the handheld electronic device can be a smartphone.

In some embodiments, the system can further comprise an intermediate reflector configured to receive optical output from the pico-projector and to direct the received optical output to the medium for viewing by a vehicle operator.

In some embodiments, the system can further comprise a mounting bracket configured to mount the apparatus to a vehicle surface or component.

In some embodiments, the mounting bracket can be configured to mount the apparatus to a vehicle windshield.

In some embodiments, the mounting bracket can be configured to mount the apparatus to a vehicle dashboard.

In some embodiments, the system can further comprise a remote control device configured to interact with the electronic device to control the optical output of the pico-projector.

### BRIEF DESCRIPTION OF THE DRAWINGS

The inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of inventive concepts. In the drawings:

FIGS. 1A-1C are representations of a conventional smartphone pico-projector combination;

FIG. 2 illustrates a side view of a conceptual arrangement of a smartphone within a pico-projector being inserted into a heads-up display, in accordance with principles of inventive concepts;

FIG. 3 illustrates a side view of a conceptual arrangement of a smartphone within a pico-projector within a heads-up display, in accordance with principles of inventive concepts;

FIG. 4 illustrates a side view of a conceptual arrangement of a smartphone within a pico-projector being removed from a heads-up display, in accordance with principles of inventive concepts;

FIG. 5 is a perspective view of the pico-projector of FIGS. 1 through 4;

FIG. 6 is a perspective view of a smartphone being inserted into the pico-projector of FIG. 5;

FIG. 7 illustrates a perspective view of an arrangement of a smartphone within a pico-projector case being inserted into a heads-up display, in accordance with principles of inventive concepts;

FIG. 8 is a perspective view of the smartphone in pico-projector case arranged with the heads up display of FIG. 7 to project an image, in accordance with principles of inventive concepts; and

FIG. 9 is a side view of the heads up display and smartphone within a pico-projector case of FIG. 8, in accordance with principles of inventive concepts.

### DETAILED DESCRIPTION

Various exemplary embodiments will be described more fully hereinafter with reference to the accompanying drawings, in which some exemplary embodiments are shown. The present inventive concepts may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments may be described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present inventive concepts.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In exemplary embodiments in accordance with principles of inventive concepts a system includes a heads-up-display for use in a vehicle, such as an automobile, truck, heavy equipment, farm implement, forestry harvester, or other vehicle. The heads-up-display, which includes a semi-transparent medium, allows an operator to view information provided, for example, from a smartphone without interfering with his view of the road ahead. An operator may interact with the heads-up-display via a tactile input device that may be mounted, for example, on a vehicle steering wheel to provide convenient access to operation of the heads-up-display and/or the smartphone from which information is being displayed. In exemplary embodiments, a pico-projector or other such projector, such as may be employed with a smartphone, may be used to project an image from a smartphone to a medium of the heads-up display; such projectors are collectively referred to herein as “pico-projector” for convenience. In exemplary embodiments, such an image may be projected directly onto the medium of the heads-up-display or it may be sent through an optical path that may include mirrors, lens, or other optical components that may be used to properly project the image in a desired fashion upon the heads-up-display.

In exemplary embodiments in accordance with principles of inventive concepts, images provided by the heads-up-display are collimated and, as a result, the images appear to be projected out in front of the display, at optical infinity, and an operator's eyes do not need to refocus between viewing the display and the outside world. A system and method in accordance with principles of inventive concepts may include a collimator specifically adapted to collimate images from a smartphone with which the system operates. Additionally, although collimated and, as a result, at optical infinity, the image may appear to be projected at various distances in front of the vehicle, in a range of from one to twenty feet in front of the windshield, for example.

In exemplary embodiments in accordance with principles of inventive concepts, a mobile device may send visible graphic, alphanumeric, or other image data in the form of images to a projector, such as a pico-projector. The projector projects the imagery through an optical assembly that collimates the imagery, thereby providing the collimated imagery to a user at any depth of field within the user's field of vision. In accordance with principles of inventive concepts, the projector may project the imagery through an optical assembly that collimates the projected imagery/data while focusing on a specific point in space in the field of view or depth of field of the user, where the user may view the imagery having the appearance of being projected at a specific distance in front of the vehicle windshield, for example.

Pico-projectors are known and incorporated in smartphones or in smartphone cases, for example. That is, a pico-projector may include a compartment that receives a cell phone and outputs its display content though a projector lens. Such projectors may employ digital light processing microelectromechanical switched (MEMS) mirrors, for example.

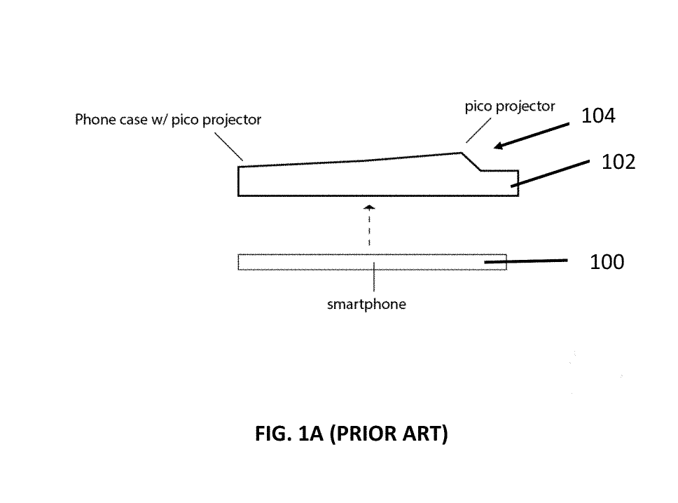

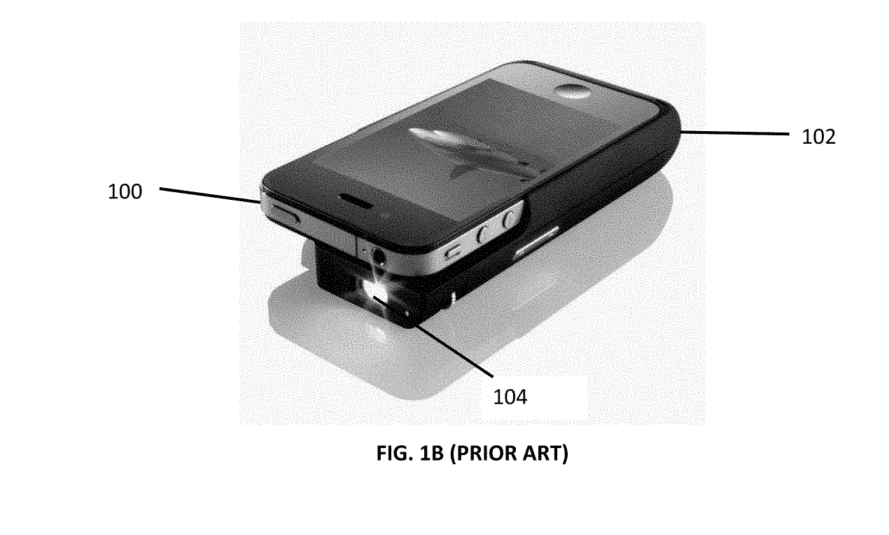

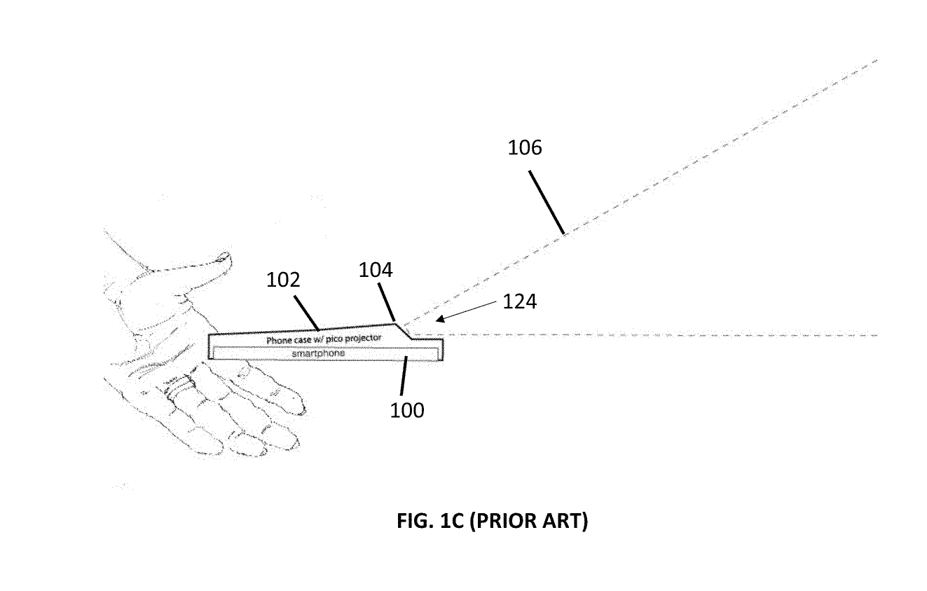

FIG. 1A illustrates a conventional combination of smartphone 100 and pico-projector case 102 that incorporates a pico-projector, or pico-projector case 102. In exemplary embodiments, the pico-projector may be powered by a power source, such as a battery power source, embedded within pico-projector case 102 or it may obtain operating power directly from smartphone 100, for example. In this exemplary embodiment, an aperture 104 is formed in pico-projector case 102 to permit the projection of images from a pico-projector lens 124, where the image originate from the smartphone 100. In order to receive images from smartphone 100, pico-projector case 102 may include an electrical interface, which may be a standard image transfer interface, for example. Although, in this exemplary embodiment, aperture 104 is shown at an angle of between 0 and 90 degree with respect to a plane of a display of the smartphone 100, that need not be the case. In some applications, such an angled aperture may provide for a better optical transmission path and in other applications an aperture co-planar with the body of smartphone 100 may provide superior performance.

FIG. 1B is a detailed image of a combined smartphone 100 and pico-projector case 102 including a pico-projector. In this conventional embodiment smartphone 100 slides into case 102, with the smartphone screen positioned for viewing by a user. The pico-projector case 102 can include a connector that couples to the charging and/or data port of the smartphone 100. All or part of the imagery displayed on the smartphone screen may be projected by the pico projector contained in the pico-projector case 102 through aperture 104.

In the plan view of FIG. 1C a conventional smartphone 100 and case 102 combination projects an image through aperture 104 extending forward as indicated by cone 106. The extent of spread in cone 106 may be determined by optical components included in case 102. Additionally, optical components in the case 102 may invert and/or reverse the image in order to make it suitable for projection through and/or reflection from other components in an optical path, such as may be employed in an exemplary embodiment in accordance with principles of inventive concepts.

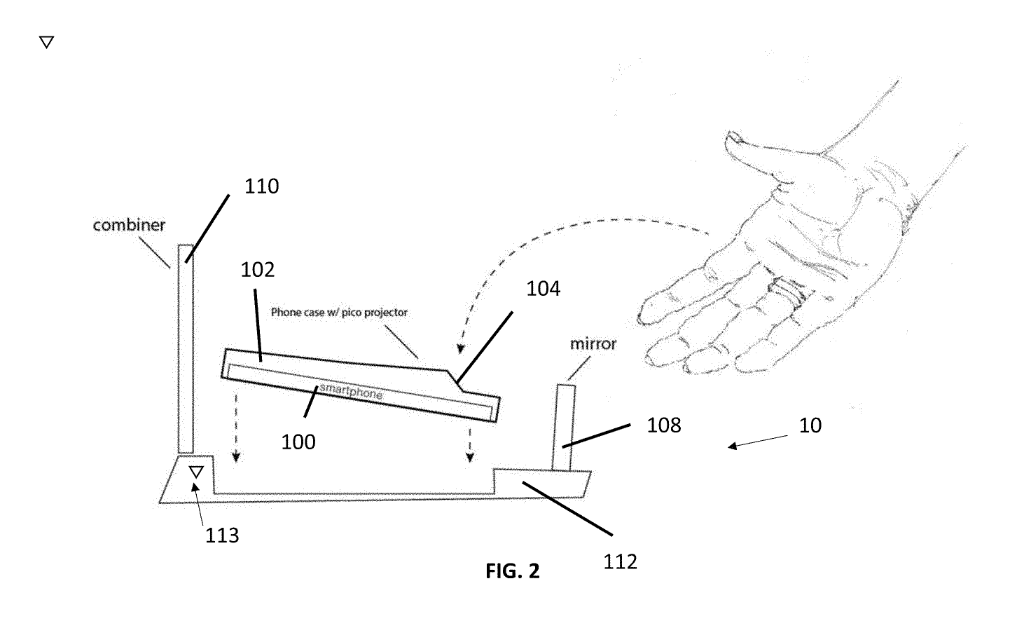

FIG. 2 illustrates a side view of a conceptual arrangement of the smartphone 100 within a case 102 having pico-projector and a heads-up display (HUD) system 10, in accordance with principles of inventive concepts. The heads-up display system 10 includes a mirror 108, a combiner 110, also referred to herein as switchable mirror 110, and a base 112. In this exemplary embodiment, the mirror 108 and the switchable mirror 110 are mounted on the base 112. Base 112 may include snaps, screws, hook and loop, or other mechanisms to hold the smartphone 100/case 102 combination in place, for example. In exemplary embodiments, the base 112 may be mounted on or near a vehicle dashboard and combiner 110 may be a combiner suitable for use as a heads-up display, such as a tunable or switchable mirror, for example. Switchable mirrors are known and described, for example, in U.S. Pat. No. 7,009,666 issued to Khan et al. and assigned to Kent Displays Incorporated. The HUD system 10 may also include an “app” (or “HUD app”) configured to drive the output of the pico-projector and/or control the switchable mirror 110.

In example embodiments, a switchable mirror 110 may include a plurality of liquid crystal layers that operate as first and second mirror layers. In exemplary embodiments, a first mirror layer may have a reflectance of 50% (and transmissivity of 50%), and a second mirror layer may have a reflectance of 40% (and transmissivity of 60%). A third layer may be a “frost” layer that, under electronic control, may switch from translucent to highly reflective. Protective layers may seal the liquid crystal layers, and may include glass or plastic, for example. Anti-reflective coatings may also be formed over the protective layers. In exemplary embodiments, switchable mirror 110 may be inclined at 90° with respect to the plane of smartphone 100 and may also be oriented to be parallel to the plane of mirror 108.

In accordance with principles of inventive concept, the degree of reflectance of switchable mirror 110 may be electronically controlled to adjust to ambient lighting conditions or other factors. Control of the reflectance may be manual or automatic. In exemplary embodiments, a light sensor may be employed to determine ambient light levels and to automatically adjust the reflectivity of the switchable mirror 110 accordingly. A smartphone camera may be employed as a light sensor for light-level sensing, for example. The heads up display system 10 can include a wireless interface 113 and a link between the smartphone and switchable mirror 110 may be implemented using a wireless link employing Bluetooth technology, for example, in order to adjust the reflectance of the switchable mirror 110 according to light levels detected by a camera within smartphone 100, for example.

In exemplary embodiments, switchable mirror 110 may be controlled in a manner that allows for greater interaction with a vehicle operator, for example, when a vehicle in which it is employed is not in motion. When the vehicle is at rest, the switchable mirror 110 may be tuned to a high degree of reflectivity (in the range of 60% to 90%, for example), allowing for more detailed graphics to be displayed to the user. Control of reflectivity may be automatic, with the system sensing motion (or lack thereof) or manual, with a user directly controlling the reflectivity of the switchable mirror 110. In accordance with principles of inventive concept, the heads-up display system 10 can be configured to prevent, or “lock out,” use of high reflectivity while the vehicle is in motion. This may be controlled by an “app” (or “HUD app”) on the smartphone 100. When the switchable mirror is in a high reflectance mode of operation, though, the HUD system 10 may be configured to present more detailed information, enabling the use of a greater range of applications. For example, an Internet browser may be displayed, allowing a user to search the Internet and interact with the browser through voice commands, for example. In various embodiments, the HUD system 10 can be configured to alter images displayed by the smartphone (for example, by inverting) to accommodate projection onto switchable mirror 110. When in an Internet mode of operation, the browser of the smartphone 100 may be configured to land on a search engine of the user's choice, for example.

In exemplary embodiments, the heads-up display system 10 may integrate a plurality of functions, such as GPS navigation, text messaging, music management, and voice telephone calls of the smartphone 100 into one HUD system. Such a HUD system 10 may provide a heads up display, voice command, and tactile interface for user interaction that requires only low levels of attention and that, consequently, requires only a low level of user attention. Voice commands available to a user may include “navigate,” “speedometer,” and “call,” for example. A user's music library, contact list, and other assets available in his smartphone 100 may be available through the HUD system 10 in accordance with principles of inventive concepts and those assets may be available through voice commands, for example, to locate and play a song, or to send a text message or voice call to a selected contact. In accordance with principles of inventive concepts, background data, such as speed, location, and usage may be collected and stored locally then uploaded to a cloud server for analytical purposes, for example, by the HUD app.

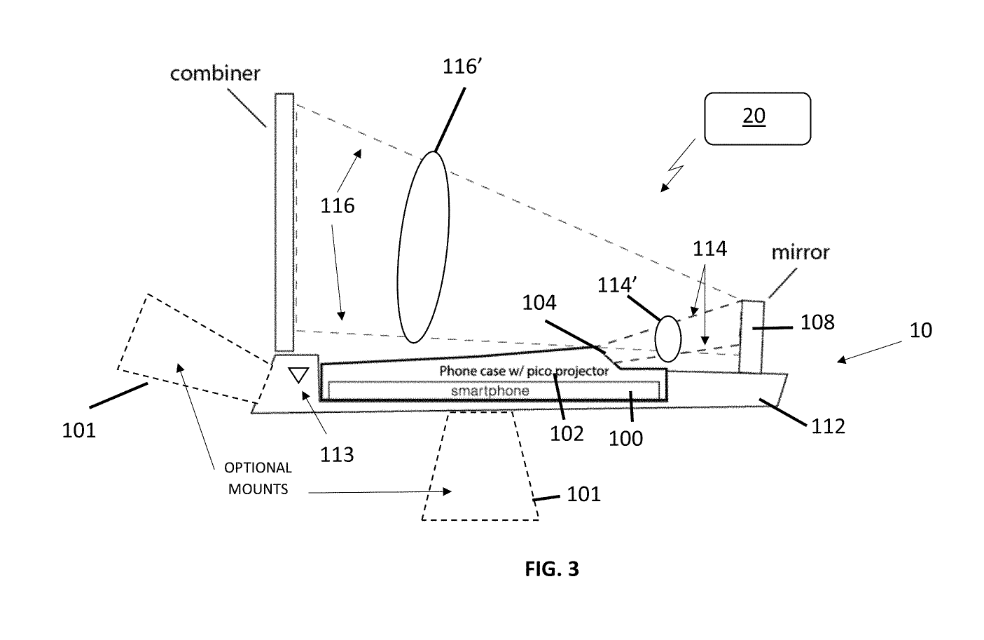

FIG. 3 illustrates a side view of a conceptual arrangement of a smartphone 100 within a case 102 having a pico-projector that is disposed within a heads-up display system 10, in accordance with principles of inventive concepts. In the exemplary embodiment of FIG. 3, the smartphone 100 is mated or inserted into case 102 having the pico-projector and the combination is, in turn, is combined with base 112 of the HUD system 10. That is, the case 102 and base 112 of the HUD system 10 can be coupled together, the case 102 can be disposed within a compartment, recess, slot, or depression of the base 112 (as shown), or some other arrangement of case 102 and base 112 can be provided wherein the pico-projector is oriented to direct its output toward mirror 108.

Rays, indicated by the dashed lines 114, define a representative extent/spread of light projected from the pico-projector of case 102 toward mirror 108. Mirror 108 may be implemented as a concave, convex, or flat mirror. In exemplary embodiments, mirror 108 is formed and positioned to reflect light from pico-projector of case 102 toward the switchable mirror 110. The reflected light is indicated by rays 116 propagating from mirror 108. In exemplary embodiments, mirror 108 may be a mirror in combination of optical elements 114′ that produce a non-inverted, non-reversed image at switchable mirror 110. Similarly, one or more optical elements 116′ may be placed in the path of rays 116. The optical elements 114′ and/or 116′ may include optical elements that reverse or invert images received from the pico-projector within case 102.

In exemplary embodiments, a tactile input device 20 may be included as a compliment to the HUD system used with a smartphone and a pico-projector. Such a tactile input device 20 may be positioned within a vehicle in a manner that allows a vehicle operator to interact with it without distraction. Such a device 20 may include a wireless link to the smartphone 100, the pico-projector (which may be incorporated within smartphone or included in case 102), and/or the switchable mirror 110, as examples. Mounts, such as either, or both of, optional mounts 101 may be employed to mount a HUD system including base 112 (and elements supported thereby), smartphone 100, and case 102 within a vehicle.

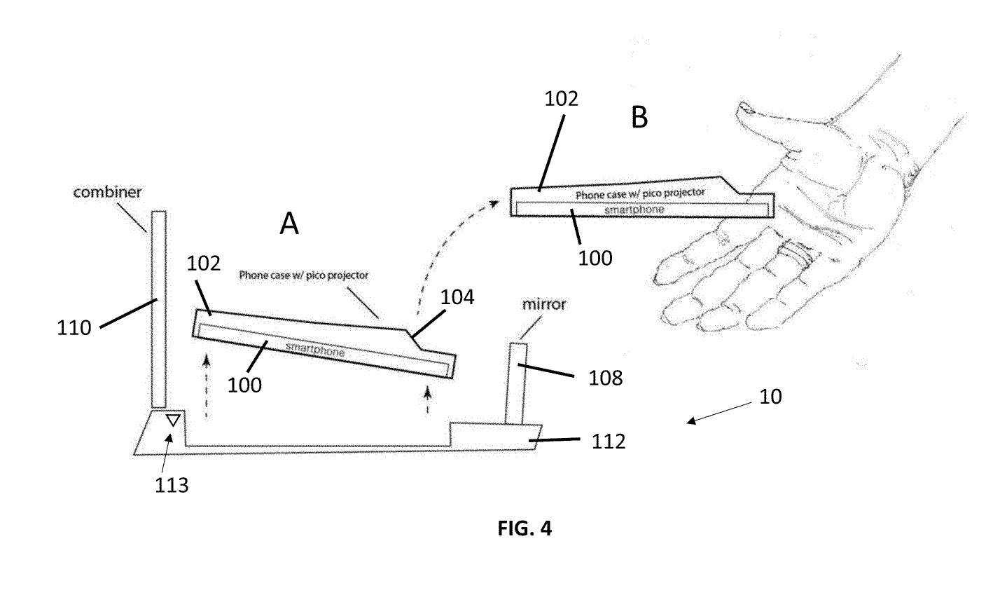

FIG. 4 illustrates a side view of a conceptual arrangement of a smartphone 100 within a pico-projector case 102 being removed from a heads-up display system 10, in accordance with principles of inventive concepts. The view of FIG. 4 illustrates the manner in which a smartphone 100/case 102 combination may be removed from a base 112, e.g., as a single insertable and removable unit. In a first position “A,” the combination has been lifted from base 112 and, in a second position “B,” the combination has been placed in a user's hand for use in a conventional fashion as a pico-projector of a smartphone display.

While not shown herein, in other embodiments the projection from the pico-projector can be directed to an area of a windshield of a vehicle, rather than to a switchable mirror. Preferably, such area of the windshield is within the forward driving direction field of view of the vehicle operator. That is, in some embodiments, the windshield can be used as a medium receiving the HUD system 10 display output.

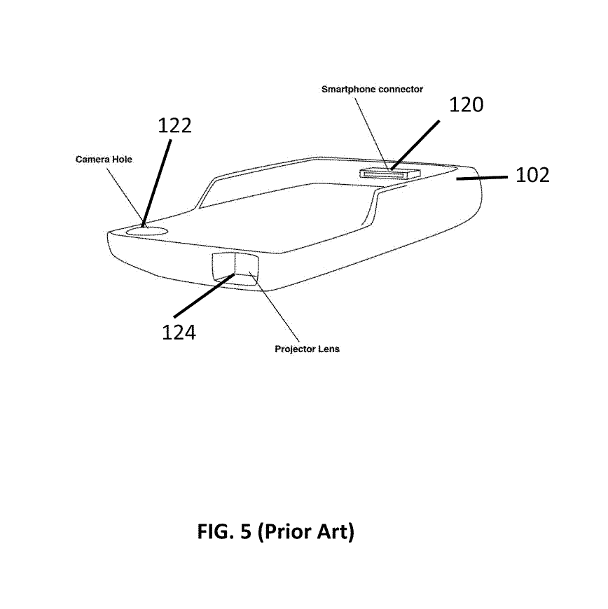

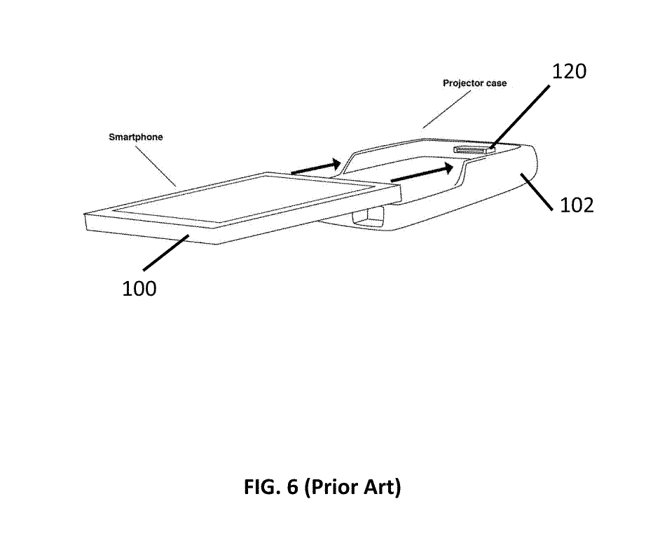

FIG. 5 is a perspective view of the pico-projector case 102 of FIGS. 1 through 4. And FIG. 6 is a perspective view of the smartphone 100 being inserted into the pico-projector case 102 of FIG. 5.

In the exemplary embodiment illustrated in the schematic view of FIG. 5 a pico-projector case 102 includes a connector 120 through which a smartphone may communicate and receive power, for example. Communications may include the transfer of display information from the smartphone 100 to the pico-projector case 102 and, from there, to be projected through pico-projector lens 124. An opening 122 formed to align with a camera of a smartphone may be included and, in exemplary embodiments in accordance with principles of inventive concepts, imagery captured by a smartphone camera through opening 122 may be transferred through connector 120 to be projected through lens 124.

The view of FIG. 6 illustrates the manner in which a smartphone 100 may be mated with and/or inserted into the pico-projector case 102. As illustrated, the smartphone 100 may insert into the case 102 so that the smartphone's charging and data port is electrically connected to electrical connector 120 of the pico-projector case 102.

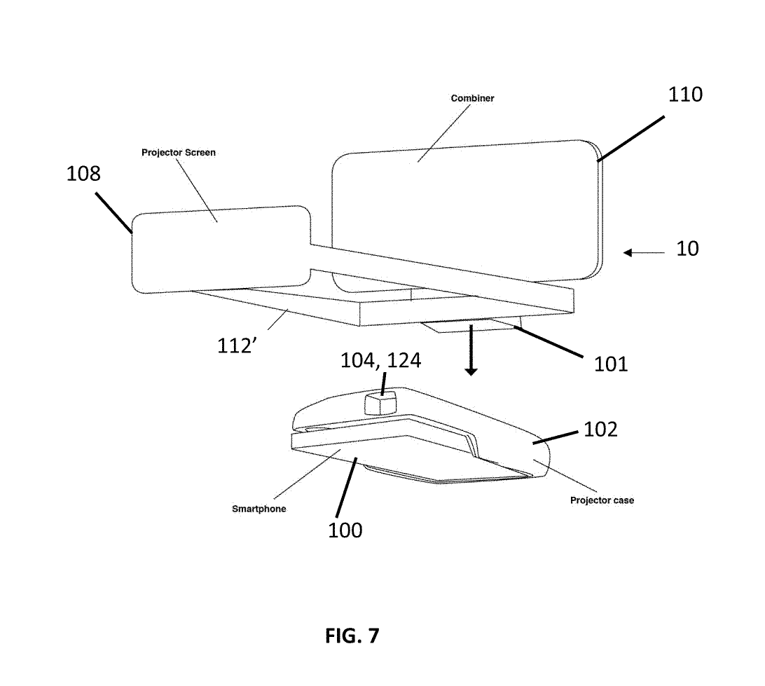

FIG. 7 illustrates a perspective view of an arrangement of a smartphone 100 within a pico-projector case 102 being inserted into a heads-up display 10, in accordance with principles of inventive concepts.

In the unassembled view of FIG. 7, a HUD system 10 in accordance with principles of inventive concepts includes an optical element 108 (for example, a mirror) and a combiner 110 separated by a frame 112′, or base. A smartphone 100 disposed within in a pico-projector case 102 is also shown. In this exemplary embodiment, a mount 101 is employed to mate with the pico-projector case 102 so that the pico-projector lens 124 output is transmitted through the combination of the mirror 108 and combiner 110 of the HUD system 10. In particular, in this exemplary embodiment, pico-projector aperture 104 and lens 124 are positionable with respect to the base 112′ to project an image onto optical element 108 for transmission to combiner 110. A pico-projector lens 124 directs display images through the aperture 104.

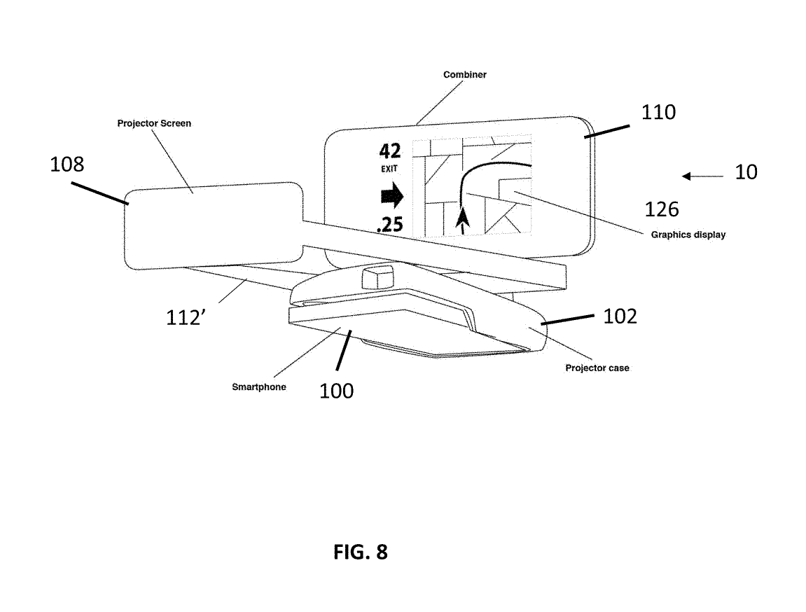

FIG. 8 is a perspective view of the smartphone 100 in pico-projector case 102 arranged with the heads up display system 10 of FIG. 7 to project an image on switchable mirror 110.

In the view of FIG. 8, an exemplary embodiment the smartphone 100 is disposed within the pico-projector case 102, which, in turn, arranged with respect to the base 112′ that supports optical element 108 and combiner 110. In this exemplary embodiment, display images 126 from smartphone 100 is viewable on combiner 110. In exemplary embodiments, the display images 126 may include both information obtained from smartphone 100 and, through partial transparency, imagery from the road in front of an operator, for example.

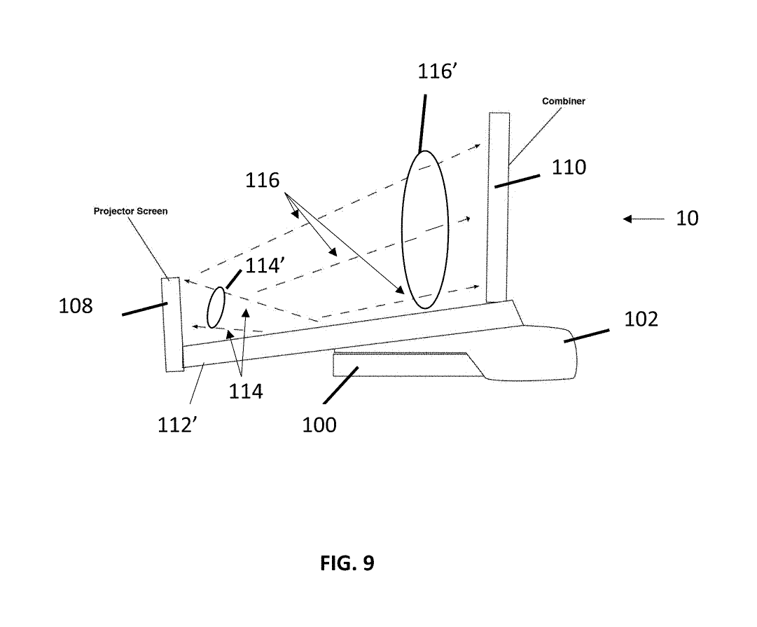

FIG. 9 is a side view of the heads up display system 10 and smartphone 100 within a pico-projector case 102 of FIG. 8, in accordance with principles of inventive concepts. The side view of FIG. 9 illustrates optical paths employed in an exemplary embodiment of a vehicle heads up display system 10, in accordance with principles of inventive concepts. In this exemplary embodiment, rays 114 represent the optical path of an image from the pico-projector lens 124 within the pico-projector base 102 to optical element 108, which may be provided through at least one optical element 114,′ e.g., a lens. Rays 116 represent an optical path from optical element 108 to combiner 110, which can also include at least one optical element 116,′ e.g., a lens. As previously indicated optical elements 114′ and 116′ may include optical components that invert, reverse, or resize images projected from the pico-projector within case 102, in order to provide an upright non-reversed image of an appropriate size for use in combiner 110.

While inventive concepts have been particularly shown and described with references to exemplary embodiments thereof, it will be understood by those skilled in the art that various changes in form and details may be made therein without departing from the scope of inventive concepts encompassed by the appended claims.

What is claimed is:

1. A vehicular heads-up-display (HUD) system, comprising:
an optical path having an at least partially reflective medium mounted for heads-up viewing in a vehicle; and
a base configured to receive a pico-projector case having a smartphone, wherein the base is structured to align a pico-projector lens so that its images are received by the at least partially reflective medium via the optical path.

2. The system of claim 1, wherein the at least partially reflective medium is a switchable mirror.

3. The system of claim 2, wherein the switchable mirror comprises an electrically switchable transreflective mirror.

4. The system of claim 1, wherein the system is responsive to a light sensor to control the reflectance and/or transmissivity of the switchable mirror.

5. The system of claim 1, wherein the system is responsive to a vehicle speed sensor to control the reflectance of the switchable mirror.

6. The system of claim 5, wherein the system is configured to increase the reflectance of the switchable mirror when the vehicle speed sensor indicates that the vehicle is not traveling.

7. The system of claim 1, wherein the switchable mirror includes a plurality of liquid crystal layers that operate as first and second mirror layers.

8. The system of claim 7, further comprising a first mirror layer having a reflectance of or about 50% and a second mirror layer having a reflectance of or about 40%.

9. The system of claim 8, further comprising a third layer as a “frost” layer that, under electronic control, switches from translucent to highly reflective.

10. The system of claim 7, further comprising:
one or more protective layers that seal the liquid crystal layers; and
one or more anti-reflective coatings formed over the one or more protective layers.

11. The system of claim 1, wherein the optical path includes a mirror coupled to the base and oriented to reflect the output of the pico-projector lens to the at least partially reflective medium.

12. The system of claim 1, wherein the pico-projector case is maintained by the base between the mirror and the at least partially reflective medium.

13. The system of claim 1, wherein the optical path includes at least one optical element configure to invert, reverse, and/or resize images projected from the pico-projector lens.

14. A vehicular heads-up-display (HUD) system, comprising:
a base configured to receive a pico-projector case having a smartphone and a pico-projector lens configured to output images from the smartphone; and
an optical path comprising:
an at least partially reflective medium mounted for heads-up viewing; and
a mirror oriented to reflect the output images of the pico-projector lens to the at least partially reflective medium.

15. The system of claim 14, wherein the base includes a compartment, recess, slot, or depression configured to receive the pico-projector case.

16. The system of claim 15, wherein the pico-projector case is maintained within the compartment, recess, slot, or depression of the base and between the mirror and the at least partially reflective medium.

17. The system of claim 16, wherein the system is configured to adjust the reflectance of the switchable mirror.

18. The system of claim 17, wherein the system is configured to increase the reflectance of the switchable mirror when the vehicle speed sensor indicates that the vehicle is not traveling.

19. The system of claim 14, wherein the switchable mirror includes a plurality of liquid crystal layers that operate as first and second mirror layers, including:
a first mirror layer having a reflectance of or about 50%;
a second mirror layer having a reflectance of or about 40%; and
a third layer as a “frost” layer that, under electronic control, switches the reflectance of the switchable mirror.

20. The system of claim 14, further comprising at least one mount to mount the system to a dashboard or windshield of a vehicle.
